(19) United States
(12) Patent Application Publication
(10) Pub. No.: US 2004/0207620 A1
(43) Pub. Date: Oct. 21, 2004

(54) Power supply, liquid crystal display device, and method of driving the same

(75) Inventor: Dong-gyun Ra, Siheung-si (KR)

Correspondence Address: McGuire Woods LLP, Suite 1800, Tysons Corner, 1750 Tysons Boulevard, McLean, VA, 22102-4215, US

(73) Assignee: Samsung Electronics Co., Ltd.

(21) Appl. No.: 10/806,380

(22) Filed: Mar. 23, 2004

(30) Foreign Application Priority Data
Apr. 21, 2003 (KR) 2003-25239

(51) Int. Cl. G09G 5/00

(52) U.S. Cl. 345/213

(57) ABSTRACT

The liquid crystal display device of the present invention comprises a timing controller, a gate driving unit, a data driving unit, a liquid crystal panel, a lamp, an inverter, a mode setting unit, and an inverter control unit. The mode setting unit discriminates a moving-image mode and a still-image mode and provides a specific control signal to the inverter control unit in accordance with the discriminated mode. The inverter control unit operates the inverter in either synchronous mode or asynchronous mode by applying or withholding a timing signal to the inverter, in response to the control signal from the mode setting unit. Preferably, the timing signal is a gate select signal CPV that becomes a horizontal synchronous signal. According to the present invention, a moiré phenomenon in still-image mode can be eliminated by driving the lamp in synchronization with the horizontal synchronous signal and the problem of lighting malfunction of the lamp in the moving-image mode can also be eliminated by driving the lamp at the frequency of the inverter itself.

### BACKGROUND OF THE INVENTION

This application claims the priority of Korean Patent Application No. 10-2003-0025239 filed on Apr. 21, 2003, in the Korean Intellectual Property Office, the disclosure of which is incorporated herein by reference.

1. Field of the Invention

The present invention relates to a power supply, a liquid crystal display device, and a method of driving the same.

2. Description of the Related Art

Generally, a liquid crystal display device comprises a liquid crystal module including a liquid crystal panel, a data driving unit and a gate driving unit, and a backlight.

Since a liquid crystal panel of a liquid crystal display device does not emit light from itself, it cannot be used in the places where there is no light. Therefore, a lamp for uniformly emitting light over the entire liquid crystal panel from the back thereof is used as a backlight.

Recently, liquid crystal display devices are widely used as a combination TV and monitor, in which moving images are mostly displayed in television mode, whereas still images are mostly displayed in monitor mode.

As a method of controlling an inverter for driving the lamp in such a liquid crystal display device, there are a synchronous method of applying a horizontal synchronous signal of the liquid crystal module to the inverter and driving the lamp at a frequency synchronous with the horizontal signal, and a asynchronous method of driving the lamp at the frequency of the inverter itself.

In case of the asynchronous method, interference (e.g., beat phenomenon) between the lamp frequency and a frame frequency is generated, and thus, a moiré phenomenon may be produced on the screen. Such a moiré phenomenon is observed more easily in still images than in moving images.

To solve such a problem, the synchronous method of applying the horizontal synchronous signal to the inverter for driving the lamp and causing the inverter to drive the lamp in synchronization with the horizontal synchronous signal has been employed.

Even in such a case, however, when changing between moving-image and still-image modes the frequency of the synchronous signal applied to the inverter temporarily increases, and thus, it exceeds the allowed value of the lamp frequency. Therefore, there is a problem of light malfunction in that the lamp goes out.

### SUMMARY OF THE INVENTION

The present invention is conceived to solve the aforementioned problems. Accordingly, an object of the present invention is to provide a power supply, a liquid crystal display device and a method of driving the same, wherein a moiré phenomenon, which may be produced on a liquid crystal display screen upon changing between moving-image and still-image modes, can be eliminated and the problem of lighting malfunctions of lamps can also be solved.

According to an aspect of the present invention for achieving the object, there is provided a power supply, which comprises a mode setting unit for outputting a control signal according to a selected display mode, an inverter control unit for selectively outputting a timing signal received from the outside according to the control signal from the mode setting unit, and an inverter which is operated in either synchronous or asynchronous mode in response to the selectively output timing signal.

According to another aspect of the present invention, there is provided a liquid crystal display device, which comprises a liquid crystal module including a liquid crystal panel, a gate driving unit for delivering scanning signals to the liquid crystal panel, and a data driving unit for delivering image signals to the liquid crystal panel; a timing controller for providing the image signals input from the outside and a timing signal used to control display of the liquid crystal module; a mode setting unit for outputting a control signal according to a selected display mode; an inverter control unit for selectively outputting the timing signal received from the timing controller according to the control signal from the mode setting unit; an inverter which is operated in either synchronous mode or asynchronous mode in response to the selectively output timing signal; and a lamp which is operated at a relevant frequency according to the operation mode of the inverter.

Further, the mode setting unit may be included in the timing controller.

According to a further aspect of the present invention, there is provided a method of driving a liquid crystal display device, which comprises the steps of (a) outputting a control signal according to a selected display mode; (b) selectively outputting, by an inverter controlling unit, a timing signal received from the outside according to the control signal; and (c) driving, by an inverter, a lamp in either synchronous or asynchronous mode according to the selectively output timing signal.

It is preferred that the display mode be either moving-image or still-image mode.

Preferably, the step (a) comprises the steps of outputting a first level control signal when the display mode is the moving-image mode, or outputting a second level control signal when the display mode is the still-image mode.

More preferably, the step (b) comprises the steps of outputting the timing signal received from the outside when the second level control signal is applied, or not outputting the timing signal received from the outside when the second level control signal is applied.

Here, the timing signal corresponds to a signal having a constant period such as a vertical synchronous signal, a horizontal synchronous signal, a gate select signal and a data clock signal. Further, an additional signal that functions as a timing signal may be generated and used.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a view illustrating a liquid crystal display device according to an embodiment of the present invention;

FIG. 2 is a block diagram of a liquid crystal display device according to an embodiment of the present invention;

FIG. 3 is a view illustrating an inverter control unit according to an embodiment of the present invention;

FIG. 4 is a block diagram illustrating an inverter according to an embodiment of the present invention;

FIG. 5 is a waveform diagram showing output voltages of respective components in the inverter shown in FIG. 4 and an electric current of a lamp; and

FIG. 6 is a flowchart illustrating a method for driving the liquid crystal display device according to an embodiment of the present invention.

### DETAILED DESCRIPTION OF THE INVENTION

Hereinafter, a preferred embodiment of the present invention will be described in detail with reference to the accompanying drawings.

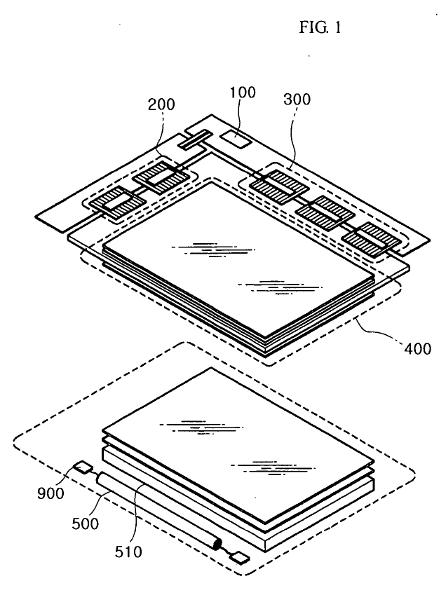

FIG. 1 is a view illustrating a liquid crystal display device according to an embodiment of the present invention.

Referring to FIG. 1, the liquid crystal display device according to the embodiment of the present invention comprises a liquid crystal module including a liquid crystal panel 400 with liquid crystal injected between two glasses thereof, driving circuits 200 and 300 for driving the liquid crystal panel 400, and a timing controller 100 for generating control signals used to control the driving circuits 200 and 300; and a backlight unit including a lamp 500, a reflection plate 510, a lamp driving unit 900 (i.e., power supply device) for applying high voltage to the lamp 500 to drive the lamp 500.

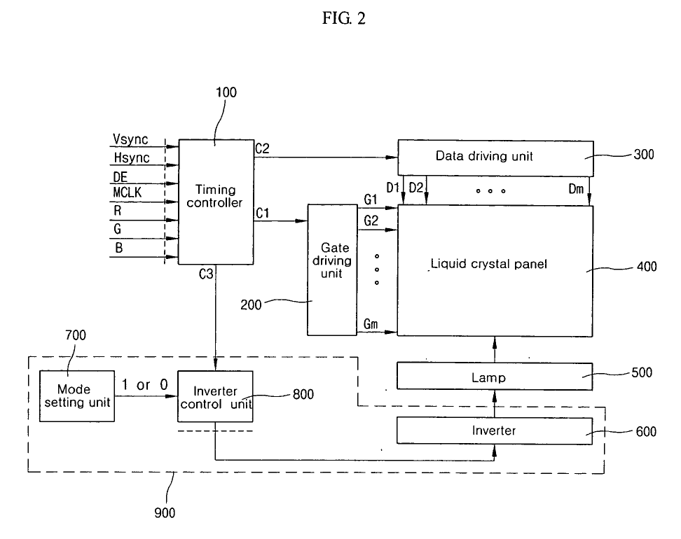

FIG. 2 is a block diagram of the liquid crystal display device according to the embodiment of the present invention.

Referring to FIG. 2, the liquid crystal display device according to the embodiment of the present invention comprises a timing controller 100, a gate driving unit 200, a data driving unit 300, a liquid crystal panel 400, a lamp 500, an inverter 600, a mode setting unit 700, and an inverter control unit 800.

In particular, the power supply device, i.e. the lamp driving unit 900 according to the embodiment of the present invention comprises the inverter 600, the mode setting unit 700, and the inverter control unit 800.

As shown in FIG. 2, the timing controller 100 receives RGB image signals R, G and B, a vertical synchronous signal Vsync, a horizontal synchronous signal Hsync, a main clock MCLK, a data enable signal DE and the like from an external graphic controller (not shown). Then, the timing controller generates first to third timing signals C1, C2 and C3 based on the vertical and horizontal synchronous signals Vsync and Hsync for controlling the display of image signals R, G and B. The generated first timing signals C1 is output to the gate driving unit 200; the generated second timing signal C2 is output to the data driving unit 300 together with the image signals R, G and B; and the generated third timing signal C3 is output to the inverter control unit 800.

Here, the first timing signal C1 includes a gate select signal CPV for controlling the output of a gate On/Off signal, a vertical synchronization start signal STV for selecting the first gate line, and an output enable signal OE.

Further, the second timing signal C2 includes a load signal TP for starting the output at an IC (integrated circuit) of the data driving unit after the transmission of image signals R, G and B, a horizontal synchronization start signal STH for informing the start of the gate lines, and a data select signal HCLK.

In the present embodiment, it is preferred that the third timing signal C3 be the gate select signal CPV of the first timing signal C1 and the gate select signal CPV be a signal of the same frequency as the horizontal synchronous signal Hsync.

The gate driving unit 200 receives the gate select signal CPV and the vertical synchronization start signal STV from the timing controller 100 and sequentially applies a plurality of gate On/Off signals G1, G2 . . . , Gn to a plurality of gate lines formed on the liquid crystal panel 400.

The data driving unit 300 receives the image signals R, G and B from the timing controller 100 and stores the image signals in a shift register (not shown). When the horizontal synchronization start signal STH is applied, the data driving unit 300 converts the image signals into the relevant voltages and then applies the converted relevant voltages to a plurality of data lines formed on the liquid crystal panel 400. At the moment when horizontal synchronization start signals STH corresponding to the first to last gate lines are input, the data driving unit 300 delivers the relevant image signals R, B and G to the liquid crystal panel 400.

The liquid crystal panel 400 comprises a plurality of pixel electrodes in the form of m×n matrix. When the gate On/Off signals G1, G2 . . . , Gn from the gate driving unit 200 are applied to pixels, the liquid crystal panel 400 drives the integrated relevant pixel electrodes in response to data voltages D1, D2, . . . , Dn provided from the data driving unit 300 so as to display images.

The lamp 500 provides desired light to the back of the liquid crystal panel. In general, EEFLs (External Electrode Fluorescence Lamps) are widely used, but CCFLs (Cold Cathode Fluorescence Lamps) may also be used.

As described above, the power supply 900 according to the embodiment of the present invention comprises the inverter 600, the mode setting unit 700 and the inverter control unit 800. In particular, the inverter 600 converts a DC voltage from the external power source into an AC voltage suitable for driving the lamp 500 and outputs the converted AC voltage, and detailed description thereof will be made below.

The mode setting nit 700 is used in the liquid crystal display device for use in a combination television and monitor to discriminate between moving-image and still-image modes and output a high-level signal “1” in case of a moving-image mode or a low-level signal “0” in case of a still-image mode, and then to apply the discriminated signal to the inverter control unit 800 to be described later. Here, the moving-image mode corresponds to a mode in which moving images are displayed as in a case where the liquid crystal display device of the present invention is used as a television etc., whereas the still-image mode corresponds to a mode in which still images are mostly displayed as in a case where the liquid crystal display device of the present invention is used as a monitor etc.

Further, it can be implemented in such a manner that the mode setting unit 700 is included in the timing controller 100.

The inverter control unit 800 can operate the inverter 600 in either synchronous or asynchronous mode by applying or withholding the third timing signal C3 to the inverter 600, in response to the control signal “1” or “0” from the mode setting unit 700.

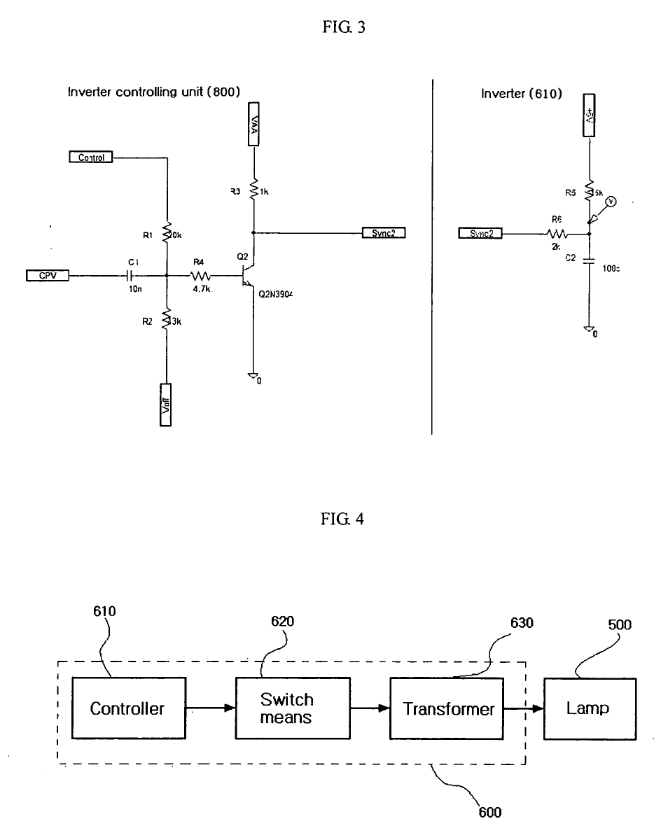

FIG. 3 is a view illustrating an inverter control unit according to the embodiment of the present invention.

As shown in FIG. 3, the inverter control unit 800 of the present invention operates the switch Q2 in response to the control signal from the mode setting unit 700 to control the application of third timing signal CPV. When the control signal is “1”, the switch Q2 enters an active state, and thus, the third timing signal CPV is input through the switch Q2 as a synchronous signal sync2 for driving the inverter 600 in the synchronous mode. When the control signal is “0”, however, the switch Q2 is turned off, and thus, the third timing signal CPV is not applied to the inverter 600.

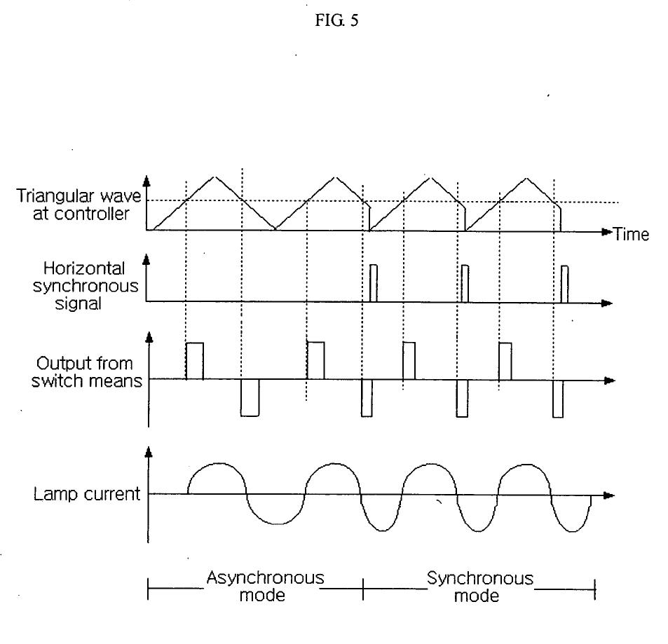

FIG. 4 is a block diagram explaining an inverter according to the embodiment of the present invention. The inverter 600 according to the present invention operates in synchronous or asynchronous mode depending on the control signal from the inverter control unit 800. Referring to FIG. 4, the inverter 600 comprises a switch means 620 for converting an external DC voltage into an AC voltage, a transformer 630 for raising the voltage that passed through the switch means 620 and applying the raised voltage to the lamp 500, and a controller 610 for controlling a switching time of the switch means 620.

In the case of synchronous mode, the synchronous signal sync2 is applied to the controller 610 which in turn controls the switching means 620 in response to the applied synchronous signal sync2 to cause the frequency of voltage applied to the lamp to be synchronized with that of the horizontal synchronous signal of the liquid crystal module.

FIG. 5 is a waveform diagram showing output voltages of respective components in the inverter shown in FIG. 4 and an electric current of the lamp. Particular, FIG. 5 shows waveforms when the inverter 600 operates in both synchronous and asynchronous modes.

Referring to FIGS. 2, 4 and 5, in the case of moving-image mode, the mode setting unit 700 outputs the high-level signal “1” and applies the control signal to the inverter control unit 800 which in turn applies the timing signal C3 from the timing controller 100 to the controller 610 of the inverter 600 such that the inverter 600 is operated in synchronous mode.

In the case of still-image mode, the mode setting unit 700 outputs a low level signal “0” and applies the control signal to the inverter control unit 800 which in turn does not apply the timing signal C3 from the timing controller 100 to the inverter 600 such that the inverter 600 is operated in asynchronous mode.

As shown in FIG. 5, in a case where the inverter 600 is operated in synchronous mode, the frequency of the lamp current is the same as that of the applied timing signal C3. The gate select signal CPV is generally used as a synchronous signal and is preferably a signal of the same frequency as the horizontal synchronous signal Hsync.

Hereinafter, a method for driving the liquid crystal display device according to the embodiment of the present invention will be described.

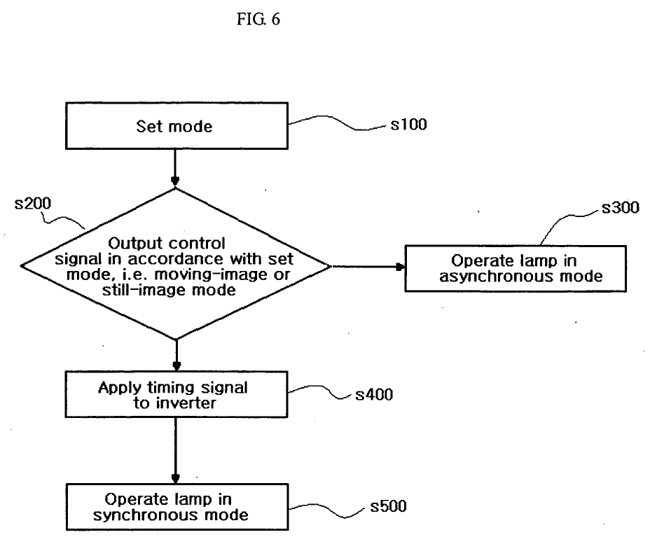

FIG. 6 is a flowchart illustrating the method for driving the liquid crystal display device according to the present invention.

As shown in FIG. 6, it is first determined whether to use the liquid crystal display device in a moving-image or still-image mode (S 100).

Here, the moving-image mode corresponds to a mode in which the moving images are displayed as in a case where the liquid crystal display device of the present invention is used as a television etc., whereas the still-image mode corresponds to a mode in which still images are mostly displayed as in a case where the liquid crystal display device of the present invention is used as a monitor etc.

Then, the mode setting unit 700 discriminates whether the moving-image or still-image mode, and outputs a first level control signal “1” in the case of moving-image mode or a second level control signal “0” in the case of still-image mode (S200). (For example, the first and second level control signals may be set as “1” and “0”, respectively.)

Next, if the first level control signal “1” is applied, the inverter control unit 800 applies the timing signal CPV received from the timing controller 100 to the inverter 600 (S400), and thus, the inverter 600 drives the lamp 500 in synchronous mode (S500).

On the other hand, if the second level control signal “0” is applied, the inverter control unit 800 does not apply the timing signal CPV received from the timing controller 100 to the inverter 600 so that the inverter 600 can drive the lamp 500 in asynchronous mode (S300).

As described above, since the moving images are always displayed on the liquid crystal panel in moving-image mode, a moiré phenomenon is not easily perceived by the human eye, whereas the moiré phenomenon is easily perceived in still-image mode where mostly still images are displayed.

Therefore, according to the present invention, the moiré phenomenon in still-image mode can be eliminated by driving the lamp in synchronization with the horizontal synchronous signal and the problem of lighting malfunction of the lamp in moving-image mode can also be eliminated by driving the lamp at the frequency of the inverter itself.

Further, since the present invention is configured such that the inverter operates in either asynchronous or synchronous mode according to the mode switching of the liquid crystal display device, the moiré phenomenon that may be generated on the liquid crystal screen can be eliminated and the problem of lighting malfunction of the lamp can be solved.

Although the present invention has been described in connection with the preferred embodiment thereof, it will be apparent to those skilled in the art that various changes and modifications can be made thereto without departing from the scope and spirit of the present invention defined by the appended claims.

For example, even though the gate select signal CPV has been used for the synchronous signal for the inverter, the horizontal or vertical synchronous signal Hsync or Vsync can be used instead. Further, an additional signal other than the existing signal can be generated and used for the synchronous signal for the inverter.

What is claimed is:

1. A power supply, comprising:
a mode setting unit for outputting a control signal according to a selected display mode;
an inverter control unit for selectively outputting a timing signal received from the outside according to the control signal from the mode setting unit; and
an inverter which is operated in either synchronous or asynchronous mode in response to the selectively output timing signal.

2. The power supply as claimed in claim 1, wherein the timing signal is a gate select signal or data clock signal.

3. The power supply as claimed in claim 1, wherein the timing signal is a vertical or horizontal synchronous signal.

4. A liquid crystal display device, comprising:
a liquid crystal module including a liquid crystal panel, a gate driving unit for delivering scanning signals to the liquid crystal panel, and a data driving unit for delivering image signals to the liquid crystal panel;
a timing controller for providing the image signals input from the outside and a timing signal used to control display of the liquid crystal module;
a mode setting unit for outputting a control signal according to a selected display mode;
an inverter control unit for selectively outputting the timing signal received from the timing controller according to the control signal from the mode setting unit;
an inverter which is operated in either synchronous mode or asynchronous mode in response to the selectively output timing signal; and
a lamp which is operated at a relevant frequency according to the operation mode of the inverter.

5. The liquid crystal display device as claimed in claim 4, wherein the timing signal is a gate select signal or data clock signal.

6. The liquid crystal display device as claimed in claim 4, wherein the timing signal is a vertical or horizontal synchronous signal.

7. The liquid crystal display device as claimed in claim 4, wherein the mode setting unit is included in the timing controller.

8. A method of driving a liquid crystal display device, comprising the steps of:
(a) outputting a control signal according to a selected display mode;
(b) selectively outputting, by an inverter controlling unit, a timing signal received from the outside according to the control signal; and
(c) driving, by an inverter, a lamp in either synchronous or asynchronous mode according to the selectively output timing signal.

9. The method as claimed in claim 8, wherein the display mode is either moving-image or still-image mode.

10. The method as claimed in claim 9, wherein step (a) comprises the steps of outputting a first level control signal when the display mode is the moving-image mode, or outputting a second level control signal when the display mode is the still-image mode.

11. The method as claimed in claim 10, wherein step (b) comprises the steps of outputting the timing signal received from the outside when the second level control signal is applied, or not outputting the timing signal received from the outside when the second level control signal is applied.

12. The method as claimed in claim 8, wherein the timing signal is a gate select signal or data clock signal.

13. The method as claimed in claim 8, wherein the timing signal is a vertical or horizontal synchronous signal.
